(19) United States
(12) Patent Application Publication
(10) Pub. No.: US 2026/0154738 A1
(43) Pub. Date: Jun. 4, 2026

(54) METHOD AND SYSTEM FOR DETERMINING ALTERNATIVE PAYMENT METHODS AT A POINT OF SALE USING OPEN BANKING

(71) Applicant: Mastercard International Incorporated, Purchase, NY (US)

(72) Inventors: David Vorhies, Saint Charles, MO (US); Christopher T. Scholl, Manchester, MO (US); Shawn Mehrhoff, Sappington, MO (US)

(73) Assignee: Mastercard International Incorporated, Purchase, NY (US)

(21) Appl. No.: 18/967,357

(22) Filed: Dec. 3, 2024

(51) Int. Cl. G06Q 40/03; G06Q 20/10; G06Q 20/34

(52) U.S. Cl. CPC G06Q 40/03; G06Q 20/108; G06Q 20/354

(57) ABSTRACT

A method for determining alternative payment methods at a point of sale using open banking comprises: receiving bank account information from a user using open banking, the bank account information including data regarding a plurality of transactions; performing a review of the transactions to determine spending habits of the user; receiving information regarding a first payment method and alternative payment methods from the user, each payment method associated with a respective one of a plurality of issuers; receiving a request for payment availability before making a purchase; contacting a first issuer associated with the first payment method; if the first issuer associated with the first payment method cannot be contacted, then determining a payment success probability that the user can make the payment for the purchase using the first payment method or the one or more alternative payment methods; and completing the purchase utilizing one of the alternative payment methods.

### FIELD OF THE INVENTION

Embodiments of the current invention relate to computer-based methods and computer-based systems that use open banking communication to determine alternative payment methods at a point of sale.

### BACKGROUND OF THE INVENTION

Purchasing goods or services using a credit or debit card, whether online or in a physical store, requires electronic communication between a merchant selling the goods or services, an issuer of the credit or debit card, and a credit network company that manages the network providing communication between the merchant and the issuer. The merchant typically contacts the issuer to verify that the user can make the payment of the purchase. If the merchant cannot contact the issuer, then the purchase cannot be completed and is cancelled.

The background discussion is intended to provide information related to the present invention which is not necessarily prior art.

### SUMMARY OF THE INVENTION

Embodiments of the current invention address one or more of the above-mentioned problems and provide methods and systems for determining alternative payment methods at a point of sale. For example, the methods and systems allow for payment methods that are associated with an issuer who can be contacted. The methods and systems also allow for the option of a new line of credit to be offered to the user at the point of sale so that the purchase can still be completed even though the issuer of the first payment method could not be reached. An embodiment of the method comprises receiving bank account information from a user using open banking, the bank account information including data regarding a plurality of transactions; performing a review of the transactions to determine spending habits of the user; receiving information regarding a first payment method and one or more alternative payment methods from the user, each payment method associated with a respective one of a plurality of issuers; receiving a request for payment availability before making a purchase; contacting a first issuer associated with the first payment method; if the first issuer associated with the first payment method cannot be contacted, then determining a payment success probability that the user can make the payment for the purchase using the first payment method or the one or more alternative payment methods; and if the first payment method has insufficient funds for the purchase, then performing at least one of the following: selecting one of the one or more alternative payment methods, prompting the user to make a selection of one of the one or more alternative payment methods and receiving the selection, or offering the user an additional line of credit as a new alternative payment method.

Another embodiment of the method comprises receiving bank account information from a user using open banking, the bank account information including data regarding a plurality of transactions; performing a review of the transactions to determine spending habits of the user; receiving information regarding a first payment method and one or more alternative payment methods from the user, each payment method associated with a respective one of a plurality of issuers; receiving a request for payment availability before making a purchase; contacting a first issuer associated with the first payment method; if the first issuer associated with the first payment method cannot be contacted, then determining a payment success probability that the user can make the payment for the purchase using the first payment method or the one or more alternative payment methods; and if the first payment method has insufficient funds for the purchase, then performing at least one of the following three options: selecting one of the one or more alternative payment methods, prompting the user to make a selection of one of the one or more alternative payment methods and receiving the selection, or offering the user an additional line of credit as a new alternative payment method; completing the purchase utilizing one of the alternative payment methods; if the user accepted the offer for the new alternative payment method which is issued by a second issuer and the second issuer cannot be contacted, then performing one of the following: receiving the payment success probability that the user can make the payment for the purchase, or receiving the user's bank account information including transaction history and determining the payment success probability; and if the payment success probability of the user being able to make the payment for the purchase is greater than a first threshold, then completing the purchase utilizing the new alternative payment method.

An embodiment of a system for determining alternative payment methods at a point of sale comprises at least one computer server operated by at least one of a merchant, an issuer, and a credit network company; and an electronic device operated by a user. The computer server or the electronic device perform the following: receiving bank account information from a user using open banking, the bank account information including data regarding a plurality of transactions; performing a review of the transactions to determine spending habits of the user; receiving information regarding a first payment method and one or more alternative payment methods from the user, each payment method associated with a respective one of a plurality of issuers; receiving a request for payment availability before making a purchase; contacting a first issuer associated with the first payment method; if the first issuer associated with the first payment method cannot be contacted, then determining a payment success probability that the user can make the payment for the purchase using the first payment method or the one or more alternative payment methods; and if the first payment method has insufficient funds for the purchase, then performing at least one of the following: selecting one of the one or more alternative payment methods, prompting the user to make a selection of one of the one or more alternative payment methods and receiving the selection, or offering the user an additional line of credit as a new alternative payment method.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is an environmental schematic view of a system, constructed in accordance with various embodiments of the current invention, for determining alternative payment methods at a point of sale using open banking, the system including at least one computer server, at least one electronic device, and a communication network;

FIGS. 2A, 2B, 2C, 2D, 2E, 2F, 2G, and 2H illustrate a schematic flow diagram illustrating a flow of data communication at each of a plurality of events; and

FIGS. 3A and 3B include a listing of at least a portion of the steps of an exemplary computer-implemented method for determining alternative payment methods at a point of sale using open banking.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

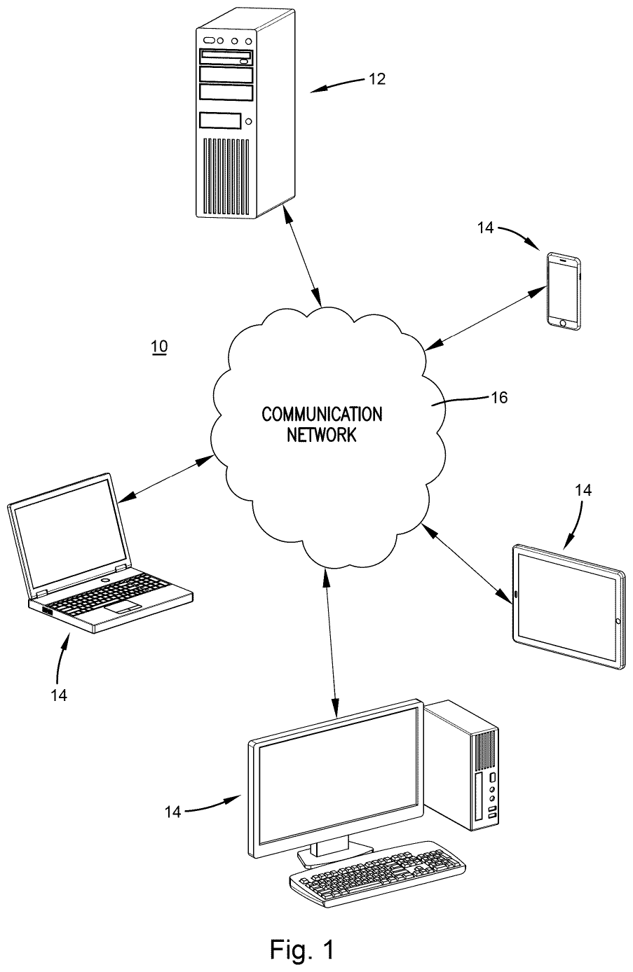

A system 10, constructed in accordance with various embodiments of the current invention, for determining alternative payment methods at a point of sale using open banking is shown in FIG. 1. The system 10 broadly comprises one or more computer servers 12, one or more electronic devices 14, and a communication network 16. The system 10 is utilized by a user who has bank account, such as checking and savings, at a first bank. The system 10 relies on the open banking electronic data communication practice to facilitate aspects of the operation of the system 10. Open banking allows third parties, such as other banks, credit companies, insurance companies, lenders, and the like which are specified by the user, access to information about the user's accounts at the first bank. The information may include data regarding financial transactions including purchases, withdrawals, and deposits. The information is used to approve the issuance by an issuer of credit and/or debits cards to the user. When the user makes a purchase of goods and services at a merchant using the credit or debit card, open banking communication allows information to be exchanged between the merchant and the issuer. The system 10 operates to provide the user an opportunity to make the purchase even when the merchant is unable to contact the issuer to complete the transaction.

The computer server 12 generally retains electronic data and may respond to requests to retrieve data as well as to store data. In addition, the computer server 12 may perform calculations or computations or make determinations based on data that is received. The computer server 12 may be embodied by application servers, database servers, file servers, gaming servers, mail servers, print servers, web servers, or the like, or combinations thereof. Furthermore, the computer server 12 may include a plurality of servers, virtual servers, or combinations thereof. The computer server 12 may also include processors, memory storage such as optical drives, hard disk drives, rack-mount drives, blade drives, and the like, and transceiver components that provide communication with the communication network 16. The computer server 12 may be configured to include or execute software such as web server applications, file storage applications, database applications, email or messaging applications, or the like. One or more computer servers 12 may be operated by merchants, credit card issuers, credit network companies such as Mastercard®, and the like who access the user's account information using open banking.

The electronic device 14 may be embodied by, or include, workstation computers, desktop computers, laptop computers, palmtop computers, notebook computers, tablets or tablet computers, smartphones, mobile phones, cellular phones, personal digital assistants (PDAs), or the like. The electronic device 14 may include processors, memory components, communication components, which, in combination, run or execute applications (apps) that allow the user to perform financial activities using open banking communication.

The memory components of the computer server 12 and the electronic device 14 may each include, constitute, or embody, a non-transitory “computer-readable medium” on which is stored instructions, code, code statements, code segments, software, firmware, programs, applications, apps, services, daemons, or the like that are executed by the processors of the respective computer server 12 and electronic device 14.

The communication network 16 generally allows communication between the electronic devices 14 and the computer server 12. The communication network 16 may include the Internet, cellular communication networks, local area networks, metro area networks, wide area networks, cloud networks, telecommunication systems, plain old or public ordinary telephone service (POTS) networks, public switched telephone networks (PSTN), and the like, or combinations thereof. The communication network 16 may be wired, wireless, or combinations thereof and may include components such as modems, gateways, switches, routers, hubs, access points, repeaters, towers, and the like. The electronic devices 14 may connect to the communication network 16 either through wires, such as electrical cables, utilizing protocols like ethernet, or fiber optic cables, or wirelessly, such as radio frequency (RF) communication using wireless standards such as cellular 2G, 3G, 4G, LTE, or 5G, Institute of Electrical and Electronics Engineers (IEEE) 802.11 standards such as WiFi, IEEE 802.16 standards such as WiMAX, Bluetooth™, or combinations thereof.

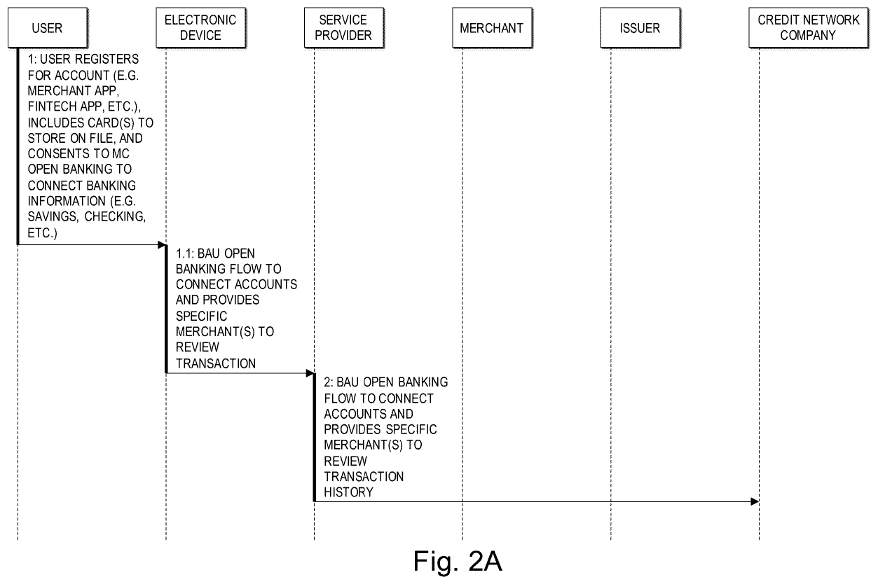

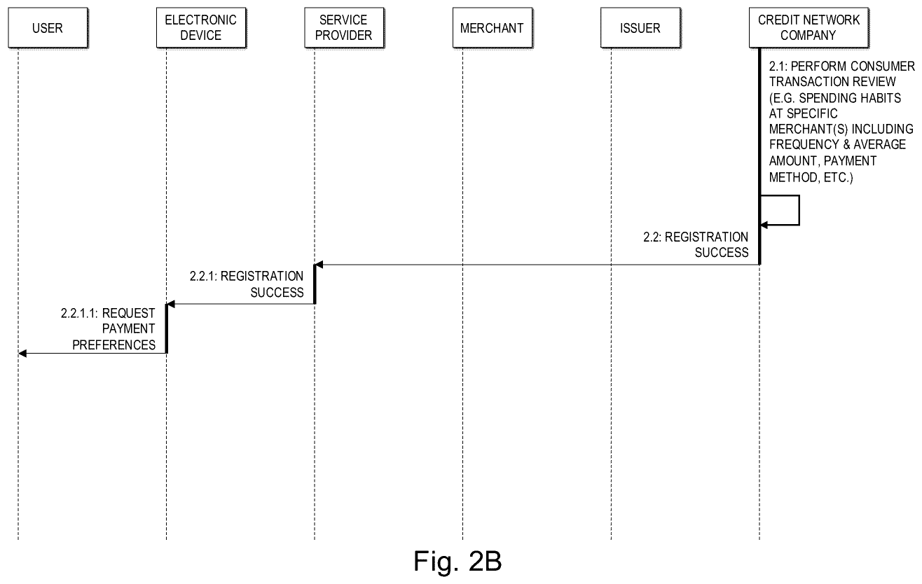

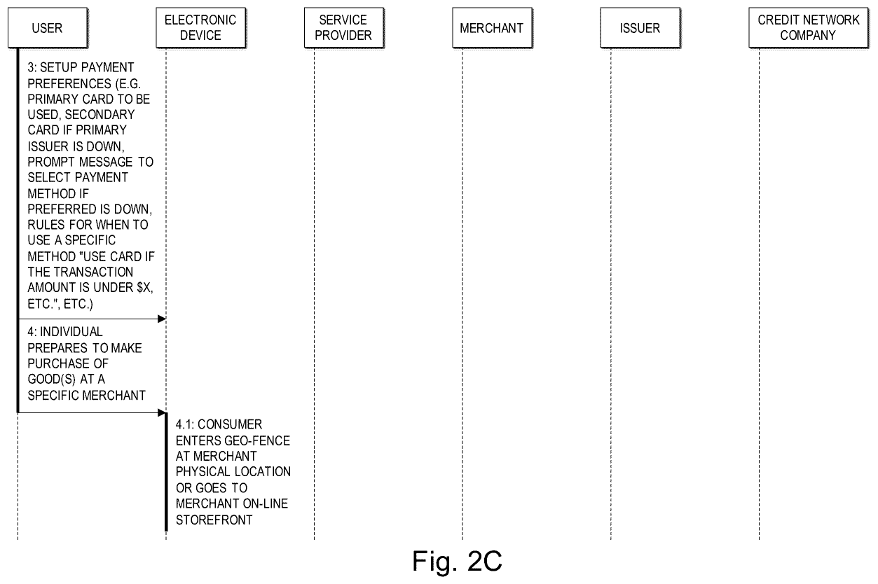

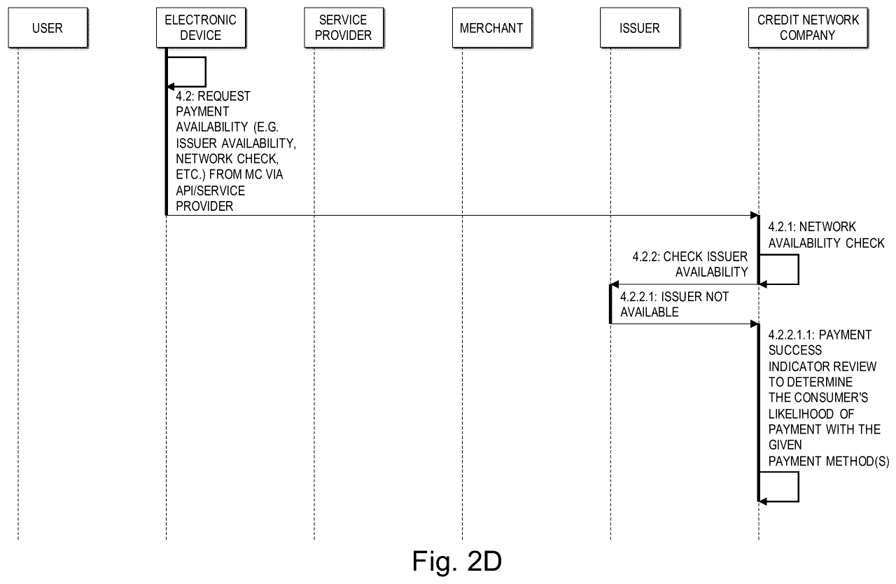

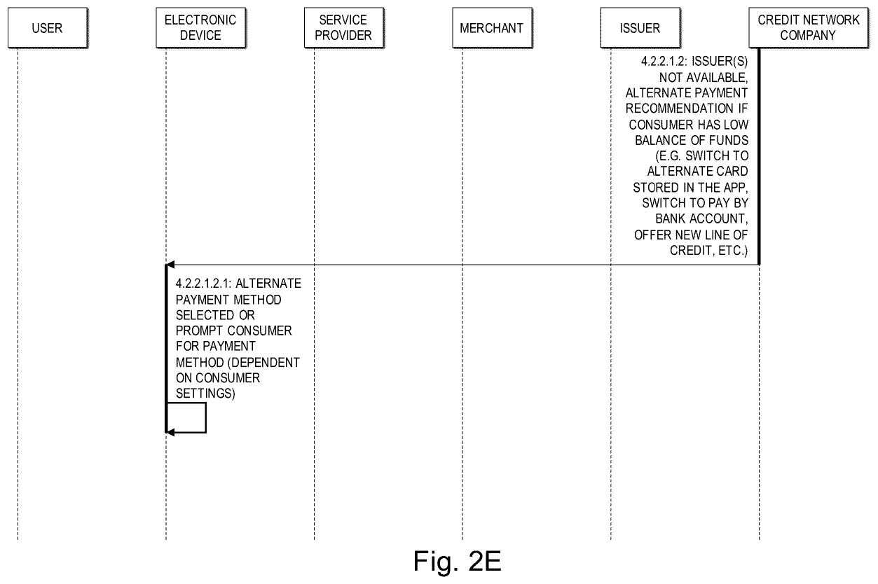

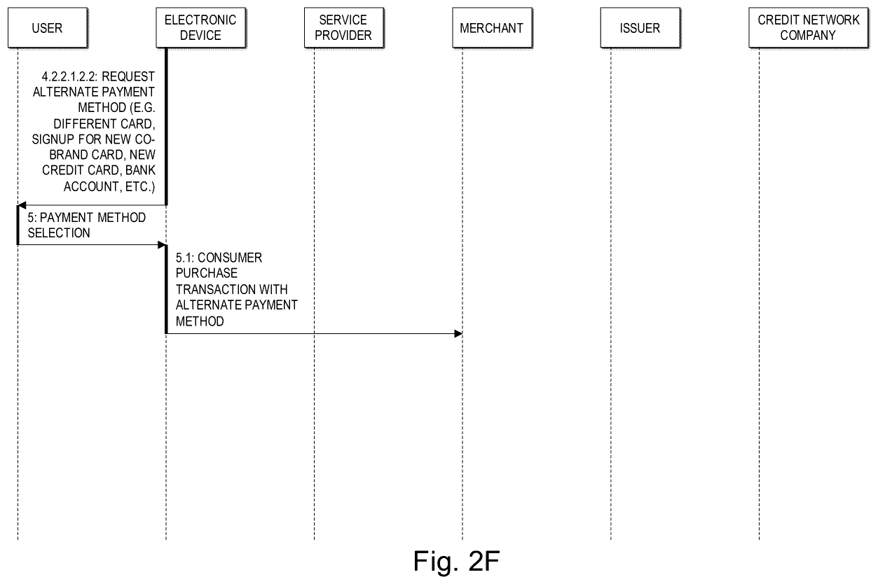

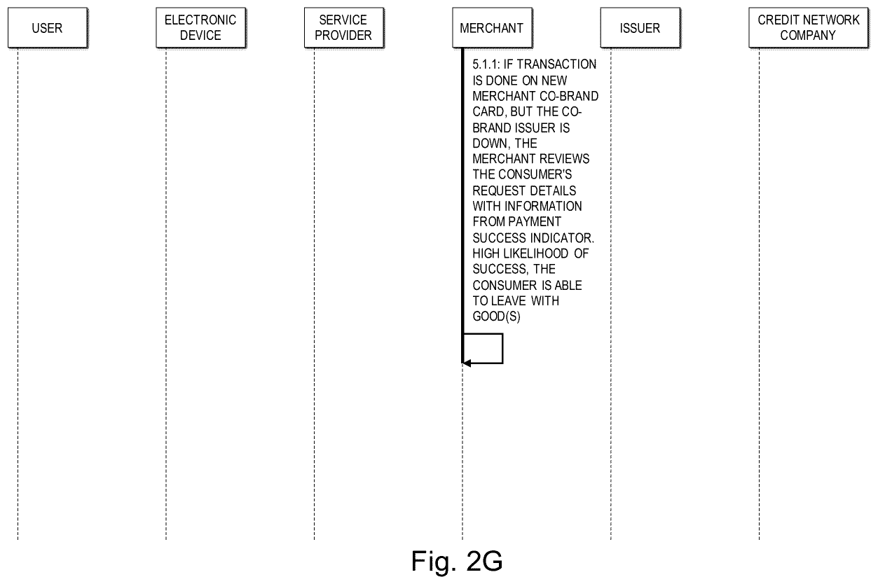

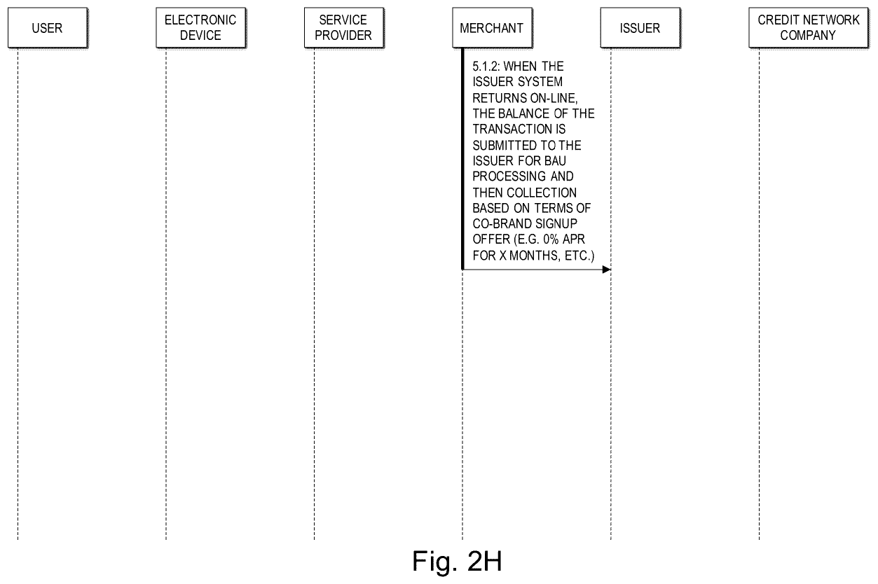

Referring to FIGS. 2A-2H, a multipage diagram is shown which illustrates the operation of the system 10. The diagram includes one or more columns associated with one or more of the components of the system 10. The columns include a first column for the user, a second column for the user's device (embodied by the electronic device 14), a third column for a service provider, a fourth column for a merchant (associated with at least one of the computer servers 12), a fifth column for an issuer (associated with at least one of the computer servers 12), and a sixth column for a credit network company (associated with at least one of the computer servers 12). The service provider includes smartphone apps, such as “wallet” or “pay” financial technology apps, and/or web browser software and interfaces which integrates access to multiple banking and/or credit card accounts. The merchant is an entity/vendor who offers goods and/or services for sale. The issuer is a financial institution that offers a line of credit for which a credit card is issued. The credit network company, such as Mastercard®, operates at least one of a plurality of credit networks that handles communications between the merchant and the issuer. The credit networks may be included in the communication network 16, or they may be independent from the communication network 16. In the columns are listed a plurality of events that occur when determining alternative payment methods at a point of sale. The events are numbered and listed in the column of the entity with which they are associated, wherein the events occur utilizing the electronic device 14 (associated with the user) or the computer server 12 (associated with the other entities). In addition, arrows indicate a direction of data flow between the entities for each event.

Referring to event 1, the user, using the electronic device 14, registers for an account, that may involve using a credit card app, financial technology app, or the like, which includes credit and/or bank cards to be stored on file. The user also consents to allow the use of open banking communication to provide merchants, issuers, and so forth with bank account information, such as checking and savings balances and transactions including withdrawals, deposits, purchases of goods and services, etc.

Referring to events 1.1 and 2, through the service provider, business as usual (BAU) open banking communication connects to the credit network company and provides the user's bank account information.

Referring to event 2.1, the credit network company reviews the bank account information including the transaction data. The credit network company may determine characteristics or features of the transaction data, such as spending habits including frequency of transactions and average transaction amount at specific merchants, payment methods, and the like.

Referring to events 2.2 and 2.2.1, pending approval from the credit network company, the registration is successful, and the appropriate apps, such as service providers, on user's electronic device 14 are notified.

Referring to event 2.2.1.1, the appropriate apps on the user's electronic device 14 prompt the user to set up his payment method preferences.

Referring to event 3, the user sets up his payment method preferences, wherein the payment method may refer to a particular credit or debit card. For example, the user may set up a preferred order of payment method usage, such as using a first payment method (a first credit or debit card from a first issuer) as a first option, using a second payment method (a second credit or debit card from a second issuer) if the first payment method is unavailable (because of inability to contact the first issuer, insufficient funds, etc.), using a third payment method (a third credit or debit card from a third issuer) if the second payment method is unavailable, and so forth. The second and third (or more) payment methods are considered alternative payment methods. The user may also set up payment method rules. For example, the user may specify to use the first payment method if the transaction amount is within a first (dollar) amount range, use the second payment method if the transaction amount is within a second amount range, and so forth.

Referring to events 4 and 4.1, the user shops online or goes to a physical store at a merchant to make a purchase. One or more apps on the user's electronic device 14 request payment availability (including issuer availability and a credit network check) from the credit network company.

Referring to events 4.2.1 and 4.2.2, the credit network company checks the availability of the credit network and if the issuer of the card associated with the first payment method is available.

Referring to events 4.2.2.1 and 4.2.2.1.1, if the issuer is not available, then the credit network company reviews the user's bank account information including transaction history and determines a first payment success probability for the user making a payment for the current purchase using any of the first, second, third, etc. payment methods. If the issuer is available, then the issuer may process the transaction as normal using the first payment method.

Referring to event 4.2.2.1.2, further assuming that the issuer of the card associated with the first payment method is not available, the credit network company recommends using one of the alternative payment methods. The credit network company may also offer a new line of credit if the first payment method has a low balance of funds. If the issuer of the card associated with the first payment method is available, and the merchant contacts the issuer to check the user's balance of funds and the first payment method has a low balance of funds, then one of the alternative payment methods is selected or the merchant offers the user a new line of credit.

Referring to event 4.2.2.1.2.1, with the user's electronic device 14, one of the alternative payment methods is automatically selected, or the user is prompted to select one of the alternative payment methods—according to settings the user has already selected.

Referring to events 4.2.2.1.2.2 and 5, if the user had selected to be prompted for alternative payment methods, the user's electronic device 14 asks the user to select one of the alternative payment methods to use in order to make the current transaction. The user then selects the alternative payment method.

Referring to event 5.1, the merchant completes the transaction using the alternative payment method.

Referring to events 5.1.1 and 5.1.2, if the user is attempting to make the purchase using an alternative payment method that includes a new line of credit from a new issuer and the new issuer is not available, then the merchant receives the user's bank account information including transaction history and determines a second payment success probability for the user making a payment for the current transaction, or the merchant receives the first payment success probability. If the payment success probability (from either determination) is above a first threshold, then the merchant completes the transaction with the user. When communication with the new issuer is available, then the balance of the transaction is submitted from the merchant to the new issuer. If the payment success probability is below the first threshold, then the transaction is not completed.

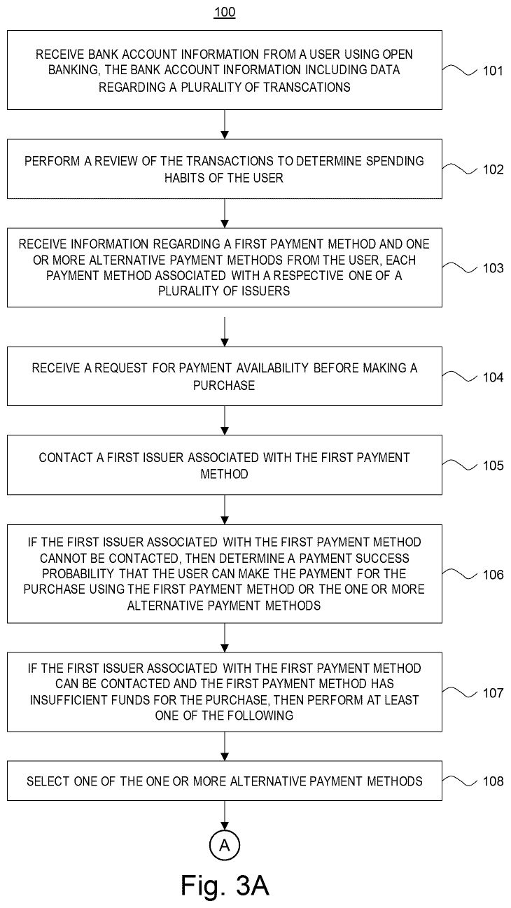

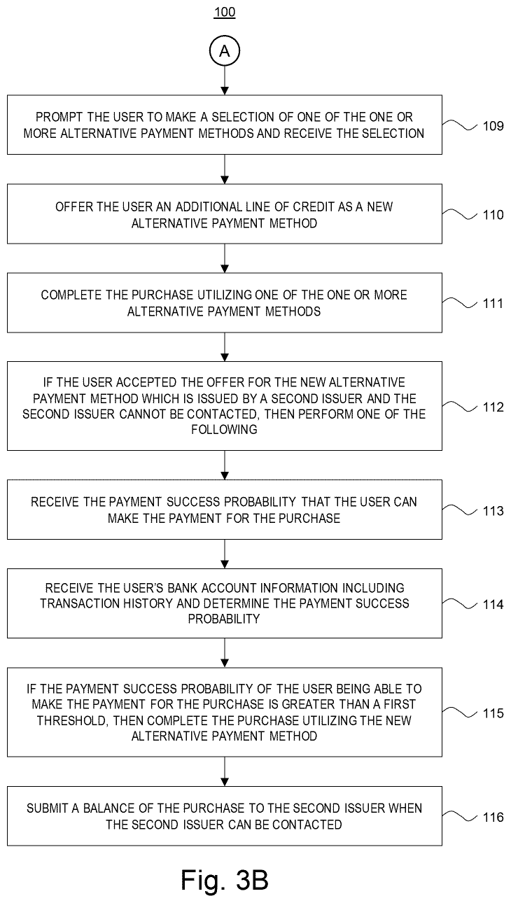

FIGS. 3A and 3B depict a listing of at least a portion of the steps of an exemplary computer-implemented method 100 for determining alternative payment methods at a point of sale using open banking. Variations to the steps may be performed. The steps may be performed in the order shown in FIGS. 3A and 3B, or they may be performed in a different order. Furthermore, some steps may be performed concurrently as opposed to sequentially. In addition, some steps may be optional or may not be performed. The steps may be performed by the processors of the computer server(s) 16 and the electronic device 14 via hardware, software, firmware, or combinations thereof. Also, the steps may be implemented as instructions, code, code segments, code statements, a program, an application, an app, a process, a service, a daemon, or the like, and may be stored on the computer-readable storage media of the computer server(s) 16 and the electronic device 14.

Referring to step 101, bank account information is received from a user who is registering for an account, that may involve using a credit card app, financial technology app, or the like, which includes credit and/or bank cards to be stored on file. The bank account information includes checking and savings balances and transactions including withdrawals, deposits, purchases of goods and services, etc. The bank account information is sent using open banking communication.

Referring to step 102, a review of the transactions is performed to determine spending habits of the user. The review is performed by a credit network company who may determine characteristics or features of the transaction data, such as spending habits including frequency of transactions and average transaction amount at specific merchants, payment methods, and the like.

Referring to step 103, information is received regarding a first payment method and one or more alternative payment methods from the user. Each payment method is associated with a respective one of a plurality of issuers and may refer to a particular credit or debit card. For example, the user may set up a preferred order of payment method usage, such as using a first payment method (a first credit or debit card from a first issuer) as a first option, using a second payment method (a second credit or debit card from a second issuer) if the first payment method is unavailable (because of inability to contact the first issuer, insufficient funds, etc.), using a third payment method (a third credit or debit card from a third issuer) if the second payment method is unavailable, and so forth. The second and third (or more) payment methods are considered alternative payment methods. The user may also set up payment method rules. For example, the user may specify to use the first payment method if the transaction amount is within a first (dollar) amount range, use the second payment method if the transaction amount is within a second amount range, and so forth.

Referring to step 104, a request is received for payment availability before making a purchase. The request is received from the user who shops online or goes to a physical store at a merchant to make the purchase. One or more apps on the user's electronic device 14 request payment availability (including issuer availability and a credit network check) from the credit network company.

Referring to step 105, a first issuer associated with the first payment method is contacted.

Referring to step 106, if the first issuer associated with the first payment method cannot be contacted, then a payment success probability that the user can make the payment for the purchase using the first payment method or the one or more alternative payment methods is determined. The credit network company may determine the payment success probability after reviewing the user's bank account information including transaction history.

Referring to steps 107, 108, 109, and 110, if the issuer associated with the first payment method can be contacted and the first payment method has insufficient funds for the purchase, then perform at least one of the following. One of the one or more alternative payment methods is automatically selected—according to settings the user has already selected. The user is prompted to make a selection of one of the one or more alternative payment methods, and the selection is received—according to settings the user has already selected. Or, the user is offered an additional line of credit as a new alternative payment method.

Referring to step 111, the purchase is completed utilizing one of the one or more alternative payment methods.

Referring to steps 112, 113, 114, 115, and 116, if the user accepted the offer for the new alternative payment method which is issued by a second issuer and the second issuer cannot be contacted, then perform the one of following. The payment success probability that the user can make the payment for the purchase is received. Or, the user's bank account information including transaction history is received and the payment success probability is determined. If the payment success probability of the user being able to make the payment for the purchase is greater than a first threshold, then the purchase utilizing the new alternative payment method is completed. A balance of the purchase is submitted to the second issuer when the second issuer can be contacted.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as communication elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method for determining alternative payment methods at a point of sale using open banking, the method comprising:
receiving bank account information from a user using open banking, the bank account information including data regarding a plurality of transactions;
performing a review of the transactions to determine spending habits of the user;
receiving information regarding a first payment method and one or more alternative payment methods from the user, each payment method associated with a respective one of a plurality of issuers;
receiving a request for payment availability before making a purchase;
contacting a first issuer associated with the first payment method;
if the first issuer associated with the first payment method cannot be contacted, then determining a payment success probability that the user can make the payment for the purchase using the first payment method or the one or more alternative payment methods; and
if the first issuer associated with the first payment method can be contacted and the first payment method has insufficient funds for the purchase, then performing at least one of the following:
selecting one of the one or more alternative payment methods,
prompting the user to make a selection of one of the one or more alternative payment methods and receiving the selection, or
offering the user an additional line of credit as a new alternative payment method.

2. The method of claim 1, further comprising completing the purchase utilizing one of the alternative payment methods.

3. The method of claim 1, further comprising:
if the user accepted the offer for the new alternative payment method which is issued by a second issuer and the second issuer cannot be contacted, then performing one of the following:
receiving the payment success probability that the user can make the payment for the purchase, or
receiving the user's bank account information including transaction history and determining the payment success probability.

4. The method of claim 3, wherein if the payment success probability of the user being able to make the payment for the purchase is greater than a first threshold, then completing the purchase utilizing the new alternative payment method.

5. The method of claim 4, further comprising submitting a balance of the purchase to the second issuer when the second issuer can be contacted.

6. The method of claim 1, wherein each payment method includes a credit card or a debit card.

7. The method of claim 1, wherein performing the review of the transactions includes determining a frequency of transactions and an average transaction amount at one or more specific merchants.

8. The method of claim 1, wherein the user selects which option to perform if the first payment method has insufficient funds for the purchase.

9. A method for determining alternative payment methods at a point of sale using open banking, the method comprising:
receiving bank account information from a user using open banking, the bank account information including data regarding a plurality of transactions;
performing a review of the transactions to determine spending habits of the user;
receiving information regarding a first payment method and one or more alternative payment methods from the user, each payment method associated with a respective one of a plurality of issuers;
receiving a request for payment availability before making a purchase;
contacting a first issuer associated with the first payment method;
if the first issuer associated with the first payment method cannot be contacted, then determining a payment success probability that the user can make the payment for the purchase using the first payment method or the one or more alternative payment methods;
if the first issuer associated with the first payment method can be contacted and the first payment method has insufficient funds for the purchase, then performing at least one of the following three options:
selecting one of the one or more alternative payment methods, prompting the user to make a selection of one of the one or more alternative payment methods and receiving the selection, or offering the user an additional line of credit as a new alternative payment method;
completing the purchase utilizing one of the alternative payment methods;
if the user accepted the offer for the new alternative payment method which is issued by a second issuer and the second issuer cannot be contacted, then performing one of the following:
receiving the payment success probability that the user can make the payment for the purchase, or
receiving the user's bank account information including transaction history and determining the payment success probability; and
if the payment success probability of the user being able to make the payment for the purchase is greater than a first threshold, then completing the purchase utilizing the new alternative payment method.

10. The method of claim 9, further comprising submitting a balance of the purchase to the second issuer when the second issuer can be contacted.

11. The method of claim 9, wherein each payment method includes a credit card or a debit card.

12. The method of claim 9, wherein performing the review of the transactions includes determining a frequency of transactions and an average transaction amount at one or more specific merchants.

13. The method of claim 9, wherein the user selects which option to perform if the first payment method has insufficient funds for the purchase.

14. A system for determining alternative payment methods at a point of sale using open banking, the system comprising:
at least one computer server operated by at least one of a merchant, an issuer, and a credit network company; and
an electronic device operated by a user,
wherein the at least one computer server or the electronic device perform the following:
receiving bank account information from a user using open banking, the bank account information including data regarding a plurality of transactions,
performing a review of the transactions to determine spending habits of the user,
receiving information regarding a first payment method and one or more alternative payment methods from the user, each payment method associated with a respective one of a plurality of issuers,
receiving a request for payment availability before making a purchase,
contacting a first issuer associated with the first payment method,
if the first issuer associated with the first payment method cannot be contacted, then determining a payment success probability that the user can make the payment for the purchase using the first payment method or the one or more alternative payment methods, and
if the first issuer associated with the first payment method can be contacted and the first payment method has insufficient funds for the purchase, then performing at least one of the following:
selecting one of the one or more alternative payment methods, prompting the user to make a selection of one of the one or more alternative payment methods and receiving the selection, or
offering the user an additional line of credit as a new alternative payment method.

15. The system of claim 14, wherein the at least one computer server or the electronic device further perform completing the purchase utilizing one of the alternative payment methods.

16. The system of claim 14, wherein the at least one computer server or the electronic device further perform
if the user accepted the offer for the new alternative payment method which is issued by a second issuer and the second issuer cannot be contacted, then performing one of the following:
receiving the payment success probability that the user can make the payment for the purchase, or
receiving the user's bank account information including transaction history and determining the payment success probability.

17. The system of claim 16, wherein if the payment success probability of the user being able to make the payment for the purchase is greater than a first threshold, then the at least one computer server or the electronic device further perform completing the purchase utilizing the new alternative payment method.

18. The system of claim 17, wherein the at least one computer server or the electronic device further perform submitting a balance of the purchase to the second issuer when the second issuer can be contacted.

19. The system of claim 14, wherein each payment method includes a credit card or a debit card.

20. The system of claim 14, wherein when performing the review of the transactions, the at least one computer server or the electronic device further perform determining a frequency of transactions and an average transaction amount at one or more specific merchants.
